(19) United States
(12) Patent Application Publication
(10) Pub. No.: US 2026/0295963 A1
(43) Pub. Date: Oct. 1, 2026

(54) ROTARY PRESS

(71) Applicant: FETTE COMPACTING GMBH, Schwarzenbek (DE)

(72) Inventors: Andreas Arning, Talkau (DE); Lennard Voigts, Hamburg (DE); Sven Kolbe, Büchen (DE); Stefan Lüdemann, Hamburg (DE)

(73) Assignee: FETTE COMPACTING GMBH, Schwarzenbek (DE)

(21) Appl. No.: 19/559,025

(22) Filed: Mar. 6, 2026

(30) Foreign Application Priority Data
Mar. 6, 2025 (DE) 10 2025 108 499.8

(51) Int. Cl. B30B 11/08; B30B 11/34

(52) U.S. Cl. CPC B30B 11/08; B30B 11/34

(57) ABSTRACT

A rotary press includes a rotor rotated by a rotary drive. The rotor includes a die plate defining a plurality of cavities and arranged between the punch guides. Upper and lower pressing punches interact with a plurality of cavities of the die plate. A filling apparatus fills the plurality of cavities with press material. A pressure apparatus interacts with the upper and lower pressing punches to press the press material to form pellets. An ejection apparatus ejects pellets produced in the rotary press. A discharge apparatus is positioned downstream of the filing apparatus in a direction of rotation of the die plate and discharges press material located on an upper side of the die plate outwardly from the die plate. A return apparatus receives the discharged press material feeds the discharged press material back to the filling apparatus.

### CROSS-REFERENCE TO RELATED APPLICATION(S)

This application claims priority to, and the benefit of, German Patent Application No. 102025108499.8, filed on Mar. 6, 2025. The entire contents of said application are incorporated herein by reference.

### TECHNOLOGICAL FIELD

The following disclosure is directed to embodiments of a rotary press that includes a rotor that can be rotated by means of a rotary drive. The rotor has an upper punch guide for upper pressing punches and a lower punch guide for lower pressing punches as well as a die plate arranged between the punch guides. The pressing punches interact with cavities of the die plate, wherein the rotary press further comprises a filling apparatus, by means of which press material to be pressed is filled into the cavities of the die plate. The rotary press further includes a pressure apparatus with an upper pressure unit and a lower pressure unit which, during operation, interact with the upper pressing punches and with the lower pressing punches in order to press the press material in the cavities of the die plate to form pellets. The rotary press further includes an ejection apparatus for ejecting pellets produced in the rotary press, and wherein, in the direction of rotation of the die plate downstream of the filling apparatus, a discharge apparatus is provided which discharges from the die plate press material located on the upper side of the die plate, which rotates relative to the discharge apparatus.

### BACKGROUND

In rotary presses, a large number of upper and lower pressing punches are generally provided which are in each case assigned to one cavity of a die plate in pairs. During operation of the rotary press, the upper and lower pressing punches rotate together with the die plate, wherein their axial movement is controlled by means of control cams and is guided by means of upper and lower punch guides. During the course of the rotation, the die plate travels through various apparatuses of the rotary press, namely a filling apparatus, in which press material to be pressed, in particular powdered press material, is filled into the cavities of the die plate, and a pressure apparatus, in which the upper and lower pressing punches are pushed into the cavities, generally by means of upper and lower pressure rollers, in order to press the material into pellets, for example tablets. Subsequent to the pressure apparatus, the upper pressing punches are guided upward out of the cavities and the pellets produced in the cavities are pushed by the lower pressing punches onto the upper side of the die plate. Such rotary presses further comprise an ejection apparatus for ejecting pellets produced in the rotary press. The ejection apparatus directs the pellets to a first or second pellet outlet. The first pellet outlet can be, for example, an outlet for pellets that are identified as good. The second pellet outlet can be, for example, an outlet for pellets that are identified as bad.

During filling of the cavities of a die plate of a rotary press, the lower pressing punches are initially moved downward, for example by corresponding cam elements, to such an extent that slightly more press material is filled into the respective cavity than is required for pressing a tablet. Subsequently, the lower pressing punches are moved upward, again for example by corresponding cam elements, by a specific amount, so that exactly the required amount of press material for pressing the desired tablet remains in the cavity. In the process, a small excess amount of press material is pressed upward out of the cavity. This excess press material is usually scraped from the upper side of the die plate by a scraper.

A pneumatic scraper is known, for example, from DE 10 2013 006 950 B3. The scraper can, according to one exemplary embodiment, completely scrape excess press material outward off the die plate. In another exemplary embodiment, reuse of excess tablet powder is possible by feeding it back to the filling apparatus. In this case, a groove is located in the die plate radially within the pitch circle formed by the cavities and receives the press material scraped inward by the scraper and can transport it back to the filling apparatus for reuse. The scraper device described in DE 10 2013 006 950 B3 comprises a force-generating apparatus that presses the scraper against the upper side of the die plate with a predetermined pressing force. To this end, the force-generating apparatus comprises a fluid cushion filled with a fluid.

The press material that is located in the groove of the die plate and is to be transported back to the filling apparatus thereby moves along the direction of movement of the die plate by approximately 360° before it is returned to the filling apparatus. Due to the substantial centrifugal forces occurring, in particular, in high-performance rotary presses, press material can be lost from the groove in the process and can be undesirably distributed within the interior of the press. Furthermore, the groove only permits the return of one press material. When pressing, for example, two different press materials to form two-layer tablets, only press material of one layer, for example of the second layer, can be returned to the filling apparatus, whereas excess press material of a second layer is lost as waste.

In view of the prior art described, it is the object of the invention to provide a rotary press of the type mentioned at the outset, which enables improved return of excess press material with reduced material loss.

### BRIEF SUMMARY

In some embodiments of the rotary press of the type mentioned at the outset, the invention achieves the object in that the discharge apparatus is configured such that it discharges press material located on the die plate outward from the die plate, and in that a return apparatus is provided which is designed such that it receives the press material discharged by the discharge apparatus and feeds it back to the filling apparatus.

The basic structure of a rotary press, as is the subject matter of the present invention, was explained at the outset. As explained, the upper and lower punch guides guide the pressing punches during their axial movement. The punch heads interact with control cams that move the pressing punches in the axial direction, in particular towards and away from each other, as they rotate with the rotor. The control cams are typically made up of several control cam elements. They can accommodate the punch heads in corresponding guide receptacles or rest only against a mirror surface of the punch heads. The pressure apparatus typically comprises an upper pressure roller and a lower pressure roller, which interact with the punch heads of the upper and lower pressing punches, respectively. Several pressure apparatuses of this type can also be provided, for example pre-pressure apparatuses and main pressure apparatuses. The ejector cam, as part of the control cams, moves the lower pressing punches upward after the pellets have been produced in their respective cavities, so that the pellets reach the upper side of the die plate, from where they can be conveyed to a first or second pellet outlet. The press material is, in particular, powdered. The pellets can be tablets. The rotary press may accordingly be a rotary tablet press. The tablets can be pharmaceutical tablets, for example.

In some embodiments, the rotary press includes a discharge apparatus which is arranged downstream of the filling apparatus and, in particular, upstream of the pressure unit in the direction of rotation of the die plate and which discharges excess press material located on the upper side of the die plate from the upper side of the die plate before the pressing in the pressure apparatus. According to the invention, the discharge apparatus discharges the press material located on the die plate radially and/or tangentially outward from the die plate with respect to the axis of rotation of the die plate. The press material can be discharged, for example, at an angle of, for example, less than 10°, for example about 5°, to the radial direction. According to the invention, a return apparatus is further provided, which receives the press material discharged outward from the die plate by the discharge apparatus and feeds the press material back to the filling apparatus. By arranging the discharge apparatus between the filling apparatus and the pressure apparatus and routing the press material outward to the return apparatus, which in turn feeds the press material to the filling apparatus fixedly arranged on an outer side of the rotating die plate, the excess press material is fed back to the filling apparatus on a direct path. In particular, unlike in the prior art, the press material does not have to undergo a nearly complete revolution with the die plate before it is fed back to the filling apparatus. Thus, the centrifugal-force-induced material losses and possible contamination in the interior of the rotary press known from the prior art are avoided. In contrast to the product return via the inner side of the die plate provided in the prior art, the centrifugal force occurring during operation is advantageously utilized according to the invention to facilitate the discharge of the press material outward. As a result, the efficiency of discharging and of returning the product to the filling apparatus is improved. Furthermore, the invention enables, in rotary presses for producing multilayer tablets and a successive layer-by-layer pressing of different press materials, a separate return of different press materials to the respective filling apparatuses of the rotary press.

In some embodiments, a sensor may be provided that monitors the proper functioning of the discharge apparatus and/or of the return apparatus. In this way, it can be ensured that, in the event of a malfunction of the discharge apparatus and/or the return apparatus, press material cannot build up in an undesired manner or enter into and remain in the pressing chamber in an undesired manner. In this way, high product loss can be avoided.

According to a particularly practical embodiment, the discharge apparatus can be a scraper apparatus, comprising a scraper, wherein the scraper is arranged above the die plate such that the scraper scrapes press material located on the die plate outward from the die plate. The scraper may be arranged directly above the die plate or be in contact with its upper side, wherein the die plate rotates beneath the scraper. The scraper can also be pressed onto the upper side of the die plate, for example by means of a force-generating apparatus, in particular a pneumatic force-generating apparatus, as described, for example, in DE 10 2013 006 950 B3.

In some embodiments, the return apparatus may comprise a receiving container that receives the press material discharged from, for example scraped off of, the die plate and from which the press material is fed back to the filling apparatus. It is also possible, however, for the discharged press material to be fed directly, i.e., without a receiving container as an intermediate container, to the filling apparatus.

In some embodiments, the return apparatus may further comprise a return channel, via which the press material is fed back to the filling apparatus. The return channel may be connected to the receiving container. The return channel may be closed or open. It can be designed, for example, as a return groove. Furthermore, the return channel may be rigid or flexible. For example, it may be a return hose.

According to a further embodiment, the return apparatus may comprise conveying means for conveying the press material to the filling apparatus and/or within the filling apparatus to a filling chamber of the filling apparatus. The conveying means may comprise, for example, pneumatic conveying means. In particular, the conveying means may comprise a Venturi nozzle. A negative-pressure or vacuum conveying of the press material by means of a negative-pressure conveying apparatus is also possible. The press material discharged from the die plate by the discharge apparatus can be rapidly fed to the filling apparatus in a controlled manner by the conveying means. By means of pneumatic conveying means, comprising, for example, a Venturi nozzle, the press material can be accelerated toward the filling apparatus. In this way, a particularly safe and reliable return of the press material to the filling apparatus is achieved in a structurally simple manner.

According to a further embodiment, the conveying means may comprise a screw conveyor. Conveying means, such as, for example, a screw conveyor, can be arranged, for example, in a centrifugal or cyclone separator and/or within a filling tube, which leads to a filling chamber, of the filling apparatus. The conveying means may also comprise a suction apparatus, which conveys the press material by means of negative pressure to the filling apparatus and/or within the filling apparatus to a filling chamber. In particular, if the return of the product takes place by means of a suction apparatus, in particular solely by a suction apparatus, and in particular when using a cyclone separator, a screw conveyor can additionally be employed to prevent press material from being inadvertently drawn in from a filling chamber, in particular a metering chamber. The screw conveyor then assumes an airlock function.

In some embodiments, reliable conveying of the filling material can be ensured even at high rotational speeds of the rotary press by a conveying means.

In some embodiments, the return apparatus may further comprise a separating apparatus for separating the press material from a conveying fluid. The separating apparatus can also effect a deceleration of the press material that was previously accelerated, for example by pneumatic conveying means. The conveying fluid may be a conveying gas, such as conveying air.

According to a particularly practical embodiment, the separating apparatus may comprise a centrifugal separator and/or a cyclone separator. By means of a centrifugal separator, also referred to as an inertial separator, or of a cyclone separator, comprising, in particular, a cyclone hopper, the press material to be returned to the filling apparatus can be separated again in a particularly reliable manner from a conveying gas conveying the press material before it is fed, for example, to a filling chamber of the filling apparatus.

According to a further embodiment, it may be provided that the filling apparatus has a filling reservoir and a filling chamber which is arranged below the filling reservoir and has a filling wheel driven in rotation therein, and that the return apparatus feeds the press material below the filling reservoir into a connecting section leading to the filling chamber and/or directly into the filling chamber of the filling apparatus. The filling chamber may form a metering chamber of the filling apparatus. The filling wheel may correspondingly be a metering wheel.

In some embodiments, the return apparatus may feed the press material, in particular, near an axis of rotation of the filling wheel. The axis of rotation may be formed by a hub of the filling wheel. The return apparatus can feed the press material immediately adjacent to the hub of the filling wheel, the hub forming the axis of rotation. By returning the press material as close as possible to the axis of rotation of the filling wheel, advantage is taken of the fact that the back pressure of the press material already circulating in the filling chamber is as low as possible. The back pressure increases from the axis of rotation to the outer diameter of the filling chamber due to the centrifugal force generated by the circulation. Due to the lower back pressure, a return into the filling chamber, in particular into the metering chamber downstream of a first filling chamber in the direction of rotation of the die plate, is enabled without the press material building up. Such a product buildup otherwise prevents an effective return of the press material into the filling chamber. Furthermore, advantage is taken of the fact that press material already located in the filling chamber tends, due to centrifugal force, to accumulate in the outer region of the filling chamber, such that a region with less press material is formed in the central region of the filling chamber in the region of the axis of rotation, which facilitates a return of press material into this region.

According to a further embodiment, the return apparatus may have a return section that opens into the filling chamber, and a barrier may be arranged in the filling chamber above the filling wheel and ahead of the return section in the direction of rotation of the filling wheel, the barrier forming a free space not filled with press material below the opening of the return section. Accordingly, a barrier is provided in the upper region of the filling chamber, in particular of the metering chamber, directly in the direction of rotation of the filling wheel, or rather of the metering wheel, in front of the opening of the return section. The barrier results in the filling chamber not being filled to the full height in the region of the opening of the return section. Thus, a free space is actively formed, which enables the additional inflow of press material through the return section.

In some embodiments the filling reservoir, which may, for example, be designed as a filling hopper, contains the press material to be pressed in the rotary press. From the filling reservoir, the press material passes into a filling chamber arranged below the filling reservoir, in particular due to gravity. A filling wheel, which is driven in rotation during operation of the filling apparatus, is typically arranged in the filling chamber. The filling wheel may, for example, have several filling wheel blades. It serves to loosen and distribute the press material, in particular to avoid product accumulations or bridging. The filling wheel can also make the filling of the cavities more uniform and thereby improve it. The filling apparatus can have several filling chambers, wherein a filling wheel driven in rotation can be located in each of the filling chambers. At least one filling chamber may be a metering chamber with a metering wheel driven in rotation therein. The return apparatus can then feed the press material near an axis of rotation of the metering wheel. By feeding the press material into a connecting section leading from the filling reservoir to the filling chamber and/or directly into a filling chamber of the filling apparatus, in particular near an axis of rotation of a filling wheel that is driven in rotation in the filling chamber, an additional suction on the press material can be generated by the action of centrifugal force, which makes it possible to return the press material into the filling apparatus and to convey the press material away via the return apparatus, in particular at even higher rotational speeds of the rotor or of the die plate of the rotary press of more than 60 revolutions per minute, preferably more than 80 revolutions per minute, for example up to 120 revolutions per minute.

According to a further embodiment, it may be provided that the rotary press further comprises a second filling apparatus, by means of which second press material to be pressed is filled into the cavities of the die plate, and that the rotary press further comprises a second pressure apparatus, with a second upper pressure unit and a second lower pressure unit, which, during operation, interact with the upper pressing punches and with the lower pressing punches in order to press the second press material or the first and second press materials in the cavities of the die plate to form pellets.

Like the first press material, the second press material is also, in particular, powdered. Using a rotary press with two filling apparatuses and two pressure apparatuses, for example two-layer tablets can be produced by successive layer-by-layer pressing of different press materials. If the rotary press has two ejection apparatuses, it is also possible to simultaneously produce single-layer tablets in double rotary press mode. In the process, only one half of the rotor is used for the production of each tablet. However—as explained at the outset—the invention provides a particular advantage when different press materials are filled into the cavities in the first filling apparatus and the second filling apparatus and are subsequently pressed by the first pressure apparatus and the second pressure apparatus, respectively.

In particular, according to a further embodiment, it may be provided that, in the direction of rotation of the die plate downstream of the second filling apparatus, a second discharge apparatus is provided which discharges from the die plate second press material located on the upper side of the die plate, which rotates relative to the discharge apparatus, wherein the second discharge apparatus is designed such that it discharges second press material located on the die plate outward from the die plate, and that a second return apparatus is provided which is arranged such that it receives the second press material discharged by the second discharge apparatus and feeds it back to the second filling apparatus. Thus, in two-layer operation of the rotary press, the press materials of both layers can be returned separately to the respective filling apparatuses. The second discharge apparatus and the second return apparatus may, in this case, in principle, be designed like the first discharge apparatus and the first return apparatus.

Alternatively, it is also possible that, in the direction of rotation of the die plate downstream of the second filling apparatus, a second discharge apparatus is provided which discharges from the die plate second press material located on the upper side of the die plate, which rotates relative to the discharge apparatus, wherein the second discharge apparatus is designed such that it discharges second press material located on the die plate inward into a return channel formed radially within the cavities in the die plate. In this case, therefore, only one of the press materials is fed directly to the filling apparatus in the manner according to the invention; the second press material, which is usually to be filled subsequently in the direction of rotation of the die plate, can then, as explained above in relation to the prior art, be fed back to the second filling apparatus via a return channel, for example a return groove, formed radially within the pitch circle of the cavities in the die plate. The second press material fed by the second discharge apparatus radially and/or tangentially inwardly, with respect to the axis of rotation of the die plate, into the return channel, or rather the return groove, can rotate in the return channel together with the die plate back to the second filling apparatus and be received again by the second filling apparatus. The second discharge apparatus may likewise be designed as a scraper apparatus, comprising a scraper, which, in this case, scrapes off the excess press material inward.

It is of course also possible, for example, for the second press material to be discharged outward from the die plate by the second discharge apparatus without feeding it back to the second filling apparatus. According to this embodiment, the excess press material can thus be conveyed out of the rotary press.

### BRIEF DESCRIPTION OF THE DRAWINGS

Exemplary embodiments of the invention are explained below in greater detail using figures. They schematically show:

FIG. 1 shows an embodiment of a rotary press according to the invention in an unrolled representation of the rotor;

FIG. 2 illustrates a perspective view of a first embodiment of a portion of the rotary press shown in FIG. 1 with a discharge apparatus and a return apparatus according to the invention;

FIG. 3 illustrates the embodiment of FIG. 2 with a partially exposed return apparatus;

FIG. 4 illustrates perspective view of a portion of the embodiment of the rotary press shown in FIG. 1 with a discharge apparatus and a return apparatus according to the invention;

FIG. 5 illustrated a partial sectional view along the line A-A of the embodiment of FIG. 4;

FIG. 6 illustrates a partial sectional view along the line B-B of the embodiment of FIG. 4;

FIG. 7 illustrates a side view of an embodiment of a filling apparatus as well as a discharge apparatus and return apparatus according to the invention; and

FIG. 8 illustrates a sectional view along the line C-C of the embodiment of FIG. 7.

If not otherwise specified, the same reference signs denote the same subject matter in the figures.

### DETAILED DESCRIPTION OF THE INVENTION

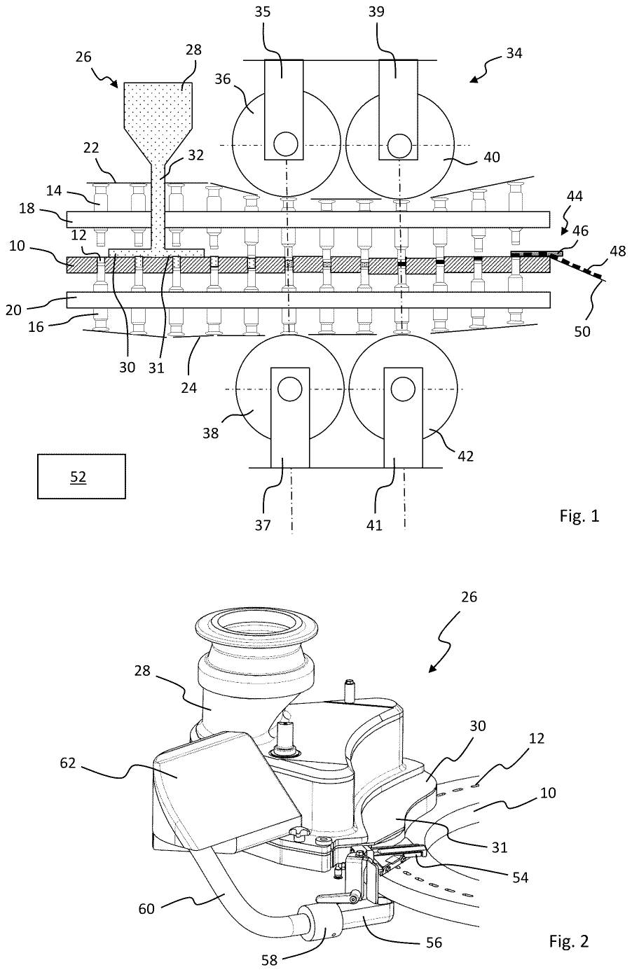

The rotary press according to the invention shown in FIG. 1 is a rotary press for producing tablets, in which powdered material is pressed to form tablets. The rotor of the rotary press is driven in rotation by a rotary drive and comprises a die plate 10 which has a plurality of cavities 12. The cavities 12 can be formed, for example, by bores in the die plate 10. The rotor further comprises a plurality of upper pressing punches 14 and lower pressing punches 16 which revolve synchronously with the die plate 10. The upper pressing punches 14 are axially guided in an upper punch guide 18 and the lower pressing punches 16 are axially guided in a lower punch guide 20. The axial movement of the upper pressing punches 14 and lower pressing punches 16 in the course of the rotation of the rotor is controlled by upper control cam elements 22 and lower control cam elements 24. The control cam elements 22, 24 are held on a cam carrier of the rotary press. Furthermore, a filling apparatus 26, shown only very schematically in FIG. 1, which has a supply funnel 28 as well as a first filling chamber 30 and a second filling chamber 31, is provided, wherein the supply funnel 28 is connected to a filling tube 32. The second filling chamber 31 can form a metering chamber. In this manner, in the present example, press material arrives from the supply funnel 28 via the filling tube 32 into the filling chambers 30, 31, for example due to gravity, and from there via an outlet provided on the underside of the filling chambers 30, 31 into the cavities 12 of the die plate 10, again, for example, due to gravity.

The rotary press further comprises a pressure apparatus 34. The pressure apparatus 34 comprises a pre-pressure apparatus with an upper pre-pressure roller 36 held on an upper holder 35 and a lower pre-pressure roller 38 held on a lower holder 37, as well as a main pressure apparatus with an upper pressure roller 40 held on an upper holder 39 and a lower pressure roller 42 held on a lower holder 41. In addition, the rotary press comprises an ejection apparatus 44 with an ejection element 46. The ejection element 46 scrapes tablets 48, which are conveyed onto the upper side of the die plate 10 by the lower pressing punches 16, from the die plate 10 and conveys the tablets 48 to a first pellet outlet 50. Furthermore, the rotary press comprises a control apparatus 52 for controlling the operation of the rotary press. The rotary press further comprises a second pellet outlet, not shown in detail in FIG. 1, that, in the direction of rotation of the die plate 10, is located ahead of the first pellet outlet 50 and can be arranged, for example, parallel thereto. By means of a sorting apparatus, comprising, for example, a sorting nozzle, tablets can be selectively conveyed into the second pellet outlet. The first pellet outlet 50 may be an outlet for tablets identified as good and the second pellet outlet may be an outlet for tablets identified as bad.

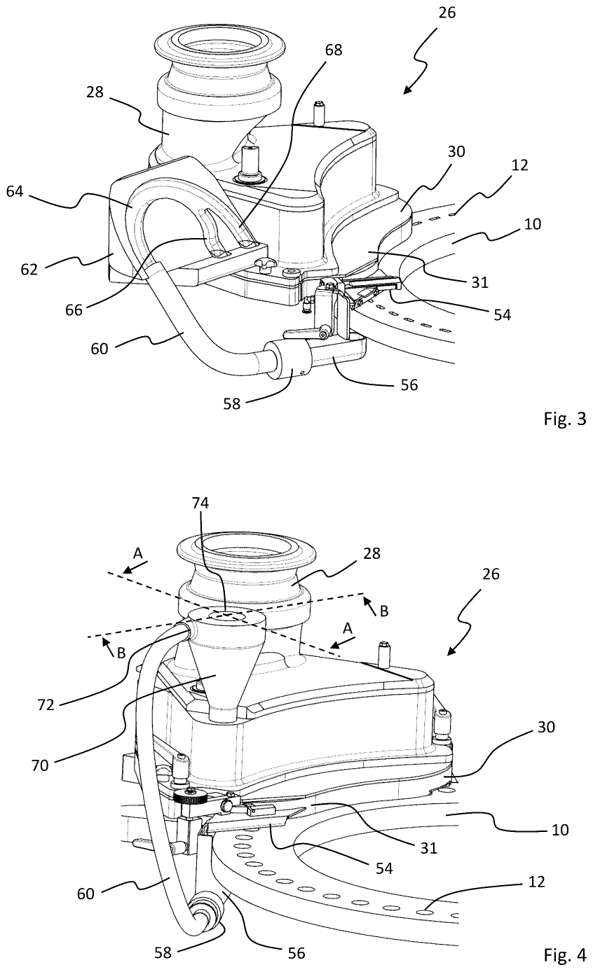

With reference to FIGS. 2 and 3, a first exemplary embodiment of a discharge apparatus and return apparatus according to the invention will be explained. The discharge apparatus is designed in the form of a scraper apparatus, comprising a scraper 54, which in the example shown scrapes excess press material located on the upper side of the die plate 10 outward from the die plate 10 into a receiving container 56 of the return apparatus. The return apparatus comprises pneumatic conveying means 58, in the present case comprising a Venturi nozzle 58, which conveys press material located in the receiving container 56 via a return channel 60 of the return apparatus to a separating apparatus 62 for separating the press material from a conveying fluid, in particular conveying air. By means of the separating apparatus 62, which in the present case is designed as a centrifugal separator 62, the press material separated from the conveying air is fed back to the filling apparatus 26, in particular into the second filling chamber 31, and thus can be used for further tablet production in the rotary press. A filling wheel driven in rotation during operation may be arranged in each of the filling chambers 30, 31. The press material can be fed near the axis of rotation of the filling wheel arranged rotatably in the second filling chamber 31, in particular immediately adjacent to a hub of the second filling chamber 31, the hub forming the axis of rotation.

In FIG. 3, for illustration purposes, the cover of the separating apparatus 62 designed as a centrifugal separator 62 is removed. As a result, a separation channel 64 of the centrifugal separator 62 is visible, in which the press material is separated from the conveying air using centrifugal force. In the example shown, the separation channel 64 branches into a conveying-air channel 66, via which the conveying air is discharged from the centrifugal separator 62, and a press-material channel 68, through which the press material separated from the conveying air is supplied to the filling chamber 31.

With reference to FIG. 4 to 6, a further exemplary embodiment of a discharge apparatus and return apparatus according to the invention will be explained. This exemplary embodiment substantially corresponds to the exemplary embodiment according to FIGS. 2 and 3. Thus, also in the exemplary embodiment according to FIG. 4 to 6, excess press material is directed by the scraper 54 of the scraper apparatus outward from the die plate 10 into a receiving container 56, from which it is supplied by means of a Venturi nozzle 58 through a return channel 60 to a separating apparatus 70 of the return apparatus, which in the present case are designed as a cyclone separator 70, in particular as a cyclone hopper 70.

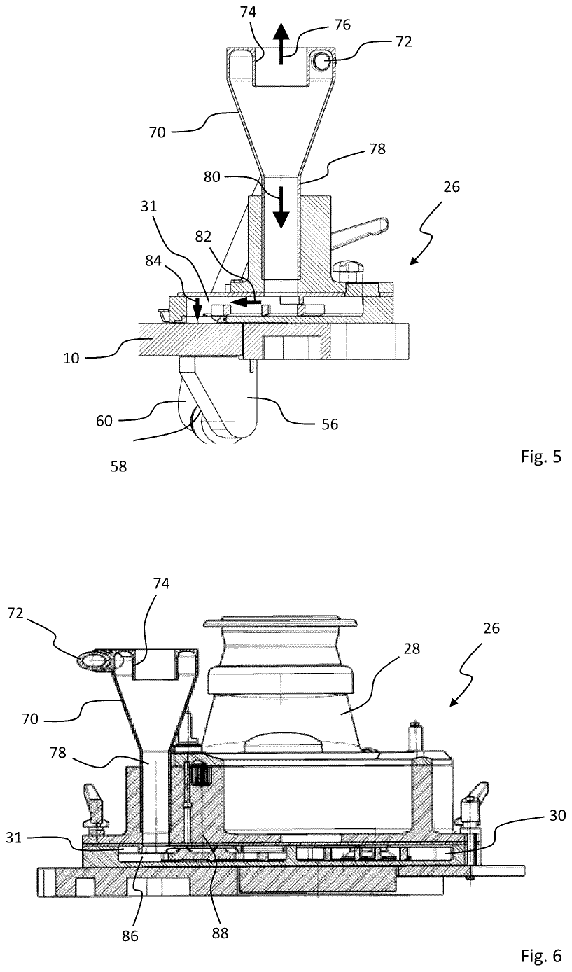

The function of the cyclone separator 70 is explained in more detail with reference to the cross-sectional views in FIGS. 5 and 6. In FIG. 5, the inlet 72 of the cyclone separator 70 can be seen, the inlet being connected to the return channel 60; through this inlet, the press material together with conveying air is fed to the cyclone separator 70. During functioning of the cyclone separator 70, the conveying air used as a transport medium is discharged upward from the cyclone separator 70 via an air outlet 74, as illustrated in FIG. 5 by the arrow 76. A suction means may be connected to the air outlet 74, the suction means facilitating the separation of the press material from the conveying fluid. The suction device can additionally suction away dust-generating powder material. The press material separated from the conveying air passes from the funnel-shaped upper section of the cyclone separator 70 into an outlet channel 78, through which it is in turn supplied to the filling apparatus 26, in particular to the second filling chamber 31, as illustrated in FIG. 5 by the arrows 80, 82, 84. In the sectional view in FIG. 6, a filling wheel 86 driven in rotation in the second filling chamber 31 can also be seen. The press material is supplied from the outlet channel 78 near the axis of rotation 88 of the filling wheel 86, in particular immediately adjacent to a hub of the filling wheel 86, the hub forming the axis of rotation, such that the centrifugal force caused by the rotation of the filling wheel 86 exerts a suction effect on the press material returned to the second filling chamber 31, which facilitates the return of the press material as well as the emptying of the cyclone separator 70. Furthermore, use is made of the fact that press material collects in the outer region of the filling chamber 31 due to the centrifugal force, thereby facilitating the return of press material in the region of the axis of rotation.

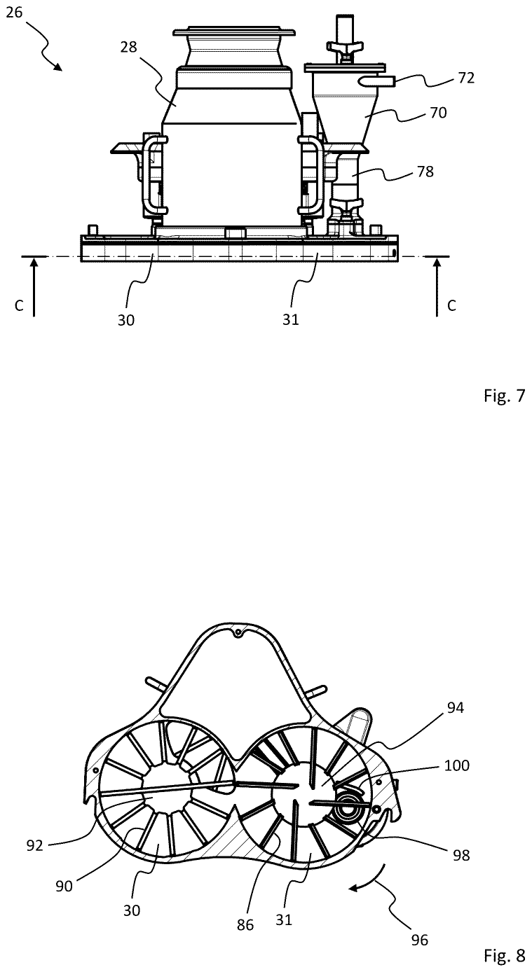

With reference to FIGS. 7 and 8, a further exemplary embodiment of the invention, which substantially corresponds to the exemplary embodiment according to FIG. 4 to 6, will be explained. Thus, a return apparatus in the form of a cyclone separator 70 is also provided in the exemplary embodiment according to FIGS. 7 and 8, wherein, for the sake of simplicity, the return channel 60 and the receiving container 56 are not shown in further detail. It is understood that the configuration of the exemplary embodiment explained below according to FIGS. 7 and 8 can also be combined with the exemplary embodiment according to FIGS. 2 and 3, in particular with the separating apparatus 62 provided there.

In the sectional view from below in FIG. 8, on the one hand, the first filling chamber 30 with a filling wheel 90 rotating therein can be seen, wherein the axis of rotation of the filling wheel 90 is formed by the hub 92 of the filling wheel 90. Adjacent to the first filling chamber 30, the second filling chamber 31 can be seen, with the filling wheel 86 rotatably arranged therein, wherein the axis of rotation of the filling wheel 86 is in turn formed by the hub 94 of the filling wheel 86. The second filling chamber 31 can, as explained, form a metering chamber. The filling wheel 86 rotatably arranged in the second filling chamber 31 can accordingly be a metering wheel 86. The direction of rotation of the filling wheel 86 rotatably arranged in the second filling chamber 31 is, in the view in FIG. 8, clockwise, as illustrated by the arrow 96. Immediately adjacent to the hub 94 forming the axis of rotation of the filling wheel 86, a return section 98 of the return apparatus opens into the second filling chamber 31 above the agitator blades of the filling wheel 86. Due to centrifugal force, press material already located in the second filling chamber 31 accumulates in the outer region of the second filling chamber 31 during operation, which facilitates the return of the press material through the return section 98 in the region immediately adjacent to the hub 94. Moreover, above the filling wheel 86, in particular above the agitator blades of the filling wheel 86, and ahead of the return section 98 in the direction of rotation of the filling wheel 86, a barrier 100 is arranged in the second filling chamber 31 and forms, below the opening of the return section 98, a free space not filled with press material, which further facilitates the return of the press material through the return section 98.

### LIST OF REFERENCE SIGNS

10 Die plate
12 Cavity
14 Upper pressing punch
16 Lower pressing punch
18 Upper punch guide
20 Lower punch guide
22 Upper control cam element
24 Lower control cam element
26 Filling apparatus
28 Supply funnel
30 First filling chamber
31 Second filling chamber
32 Filling tube
34 Pressure apparatus
35 Upper holder
36 Upper pre-pressure roller
37 Lower holder
38 Lower pre-pressure roller
39 Upper holder
40 Upper pressure roller
41 Lower holder
42 Lower pressure roller
44 Ejection apparatus
46 Scraper
48 Tablets
50 Pellet outlet
52 Control apparatus
54 Scraper
56 Receiving container
58 Pneumatic conveying means/Venturi nozzle
60 Return channel
62 Separating apparatus/centrifugal separator
64 Separation channel
66 Conveying fluid channel
68 Press material channel
70 Separating apparatus/cyclone separator/cyclone hopper
72 Inlet
74 Air outlet
76 Arrow
78 Outlet channel
80 Arrow
82 Arrow
84 Arrow
86 Filling wheel
88 Axis of rotation
90 Filling wheel
92 Hub
94 Hub
96 Arrow
98 Return section
100 Barrier

1. A rotary press, comprising:
a rotor configured to be rotated by a rotary drive, wherein the rotor includes,
an upper punch guide for upper pressing punches,
a lower punch guide for lower pressing punches, and
a die plate defining a plurality of cavities and arranged between the punch guides, wherein the upper and lower pressing punches are configured to interact with a plurality of cavities of the die plate;
a filling apparatus configured to fill press material into the plurality of cavities of the die plate;
a pressure apparatus including an upper pressure unit and a lower pressure unit which, during operation, interact with the upper and lower pressing punches to press the press material in the plurality of cavities of the die plate to form pellets;
an ejection apparatus configured to eject pellets produced in the rotary press;
wherein a discharge apparatus positioned downstream of the filing apparatus in a direction of rotation of the die plate, wherein the die plate rotates relative to the discharge apparatus and the discharge apparatus is configured to discharge press material located on an upper side of the die plate outwardly from the die plate; and
a return apparatus configured to receive the discharged press material by the discharge apparatus and to feed the discharged press material back to the filling apparatus.

2. The rotary press according to claim 1, wherein the discharge apparatus comprises a scraper apparatus that includes a scraper, wherein the scraper is arranged above the die plate and wherein the scraper scrapes press material located on the die plate outward from the die plate.

3. The rotary press according to claim 1, wherein the return apparatus comprises a receiving container configured to receive the press material discharged from the die plate, and wherein the press material received in the receiving container is fed back to the filling apparatus.

4. The rotary press according to claim 1, wherein the return apparatus comprises a return channel via which the press material is fed back to the filling apparatus.

5. The rotary press according to claim 1, wherein the return apparatus comprises a conveying means configured to convey the press material to at least one of: (i) the filling apparatus; or (ii) within the filling apparatus to a filling chamber of the filling apparatus.

6. The rotary press according to claim 5, wherein the conveying means comprises pneumatic conveying means.

7. The rotary press according to claim 5, wherein the conveying means comprises a Venturi nozzle.

8. The rotary press according to claim 5, wherein the conveying means comprises at least one of: (i) a screw conveyor; or (ii) a suction apparatus.

9. The rotary press according to claim 5, wherein the return apparatus comprises a separating apparatus configured to separate the press material from a conveying fluid, and wherein the separating apparatus comprises at least one of: (i) a centrifugal separator; or (ii) a cyclone separator.

10. The rotary press according to claim 1, wherein the filling apparatus includes a filling reservoir and a filling chamber that is arranged below the filling reservoir and includes a filling wheel driven that is rotationally therein, and wherein the return apparatus feeds the press material below the filling reservoir into a connecting section leading into at least one of: (i) the filling apparatus; or the filling chamber of the filling apparatus.

11. The rotary press according to claim 10, wherein the return apparatus is configured to feed the press material adjacent to an axis of rotation of the filling wheel.

12. The rotary press according to claim 11, wherein the return apparatus comprises a return section that opens into the filling chamber, wherein a barrier is arranged in the filling chamber above the filling wheel and ahead of the return section in the direction of rotation of the filling wheel, and wherein the barrier forms a free space not filled with press material below an opening of the return section.

13. The rotary press according to claim 1, wherein the rotary press further comprises:
a second filling apparatus configured to fill a second press material into the plurality of cavities of the die plate; and
a second pressure apparatus with a second upper pressure unit and a second lower pressure unit, which, during operation, interact with the upper and lower pressing punches in order to press: (i) the second press material; or (ii) the press material and second press material in the plurality of cavities of the die plate to form pellets.

14. The rotary press according to claim 13, further comprising:
a second discharge apparatus positioned downstream of the second filling apparatus in the direction of rotation of the die plate, wherein the second discharge apparatus is configured to rotate relative to the die plate and discharge second press material located on the upper side of the die plate outwardly from the die plate; and
a second return apparatus configured to receive the second press material discharged by the second discharge apparatus and feeds the second press material discharged by the second discharge apparatus back to the second filling apparatus.

15. The rotary press according to claim 13, a second discharge apparatus positioned downstream of the second filling apparatus in the direction of rotation of the die plate, wherein the second discharge apparatus is configured to rotate relative to the die plate and discharge second press material located on the upper side of the die plate inwardly from the die plate and into a return channel formed radially within the plurality of cavities in the die plate.
